(19) United States
(12) Patent Application Publication
(10) Pub. No.: US 2006/0190679 A1
(43) Pub. Date: Aug. 24, 2006

(54) Content addressable memory supporting multiple width searches

(76) Inventors: Alan R. Albrecht, Granite Bay, CA (US); Jonathan Edward Greenlaw, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/060,978

(22) Filed: Feb. 18, 2005

(51) Int. Cl. G06F 12/00

(52) U.S. Cl. 711/108

(57) ABSTRACT

One embodiment disclosed relates to a content addressable memory (CAM) supporting multiple width entries. The CAM includes a plurality of rows for storing bits in an array, and at least one width bit reserved in every row to indicate a width of an entry. At least two comparand registers are included, each comparand register configured to compare bits with a different subset of the rows in the array. Another embodiment disclosed relates to a method of searching a content addressable memory (CAM) supporting multiple width entries. A search word of a supported width is received, and a determination is made as to the width of the search word. Reserved width bits in comparand registers are set to indicate the width of the search word. The search word is loaded into the comparand registers, and a comparison operation is executed. Other embodiments are also disclosed.

### BACKGROUND OF THE INVENTION

1. Field of the Invention

The present invention relates generally to networking and communications technology.

2. Description of the Background Art

Content addressable memory (CAM) devices are designed to accelerate applications that requires extremely fast searches of a database, list, pattern, image, or voice recognition stored within a computer or a communication network. CAM devices include binary CAM devices and ternary CAM devices. One advantage of a CAM device is that very quick searches can be undertaken.

An illustrative conventional configuration for a CAM 101 is depicted in FIG. 1. The CAM 101 is accessed by supplying data of interest (referred to as a “comparand”) at a comparand input port 103. Each storage entry 105 in the CAM 101 includes, or is otherwise associated with, compare logic that compares the value stored in the entry 105 with the comparand. The resulting signals, each indicating whether a match occurred, may be supplied to a priority encoder 107. The priority encoder 107 may be configured with logic to generate an address 109 that indicates one of the matching entries (for example, the lowest address associated with a matching entry 105).

The conventional CAM architecture discussed above supports a single search word data width. However, in some network devices, different packet types can require different sizes of search words. For example, IPv4 (Internet Protocol version 4) and IPv6 (Internet Protocol version 6) packets may require different sizes of search words due to the different number of IP address bits under IPv4 and IPv6. In these situations, it would be very useful to have support for multiple different widths of searches.

Some prior CAM architectures support defining portions of the search table as one size and other portions of the table as a second size. This configuration appears to be relatively static and inflexible in its partitioning of the search table into different data word sizes.

It is desirable to improve data processing technology. In particular, it is desirable to improve content addressable memories.

### SUMMARY

One embodiment of the invention relates to a content addressable memory (CAM) supporting multiple width entries. The CAM includes a plurality of rows for storing bits in an array, and at least one width bit reserved in every row to indicate a width of an entry. At least two comparand registers are included, each comparand register configured to compare bits with a different subset of the rows in the array.

Another embodiment of the invention relates to a method of searching a content addressable memory (CAM) supporting multiple width entries. A search word of a supported width is received, and a determination is made as to the width of the search word. Reserved width bits in comparand registers are set to indicate the width of the search word. The search word is loaded into the comparand registers, and a comparison operation is executed.

Other embodiments are also disclosed.

### BRIEF DESCRIPTION OF THE DRAWINGS

FIG. 1 is a diagram illustrating a conventional CAM configuration.

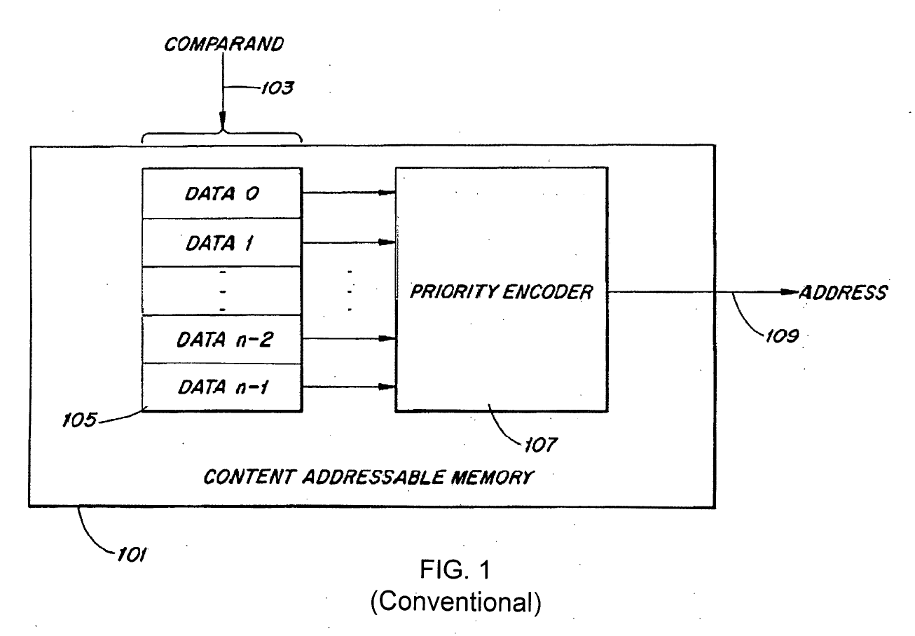

FIG. 2A is a diagram depicting an array of data word entries in a CAM supporting searches of two different widths in accordance with an embodiment of the invention.

FIG. 2B is a diagram showing circuitry for obtaining comparison results from a CAM with two different widths in accordance with an embodiment of the invention.

FIG. 3 is a flow chart depicting a method of performing a search over the CAM of FIG. 2 in accordance with an embodiment of the invention.

FIG. 4 is a diagram depicting an array of data word entries in a CAM supporting searches of three different widths in accordance with an embodiment of the invention.

FIG. 5 is a flow chart depicting a method of performing a search over the CAM of FIG. 4 in accordance with an embodiment of the invention.

### DETAILED DESCRIPTION

An embodiment of the present invention provides a CAM architecture that supports searches of two or more widths in a single CAM device. Advantageously, the CAM architecture disclosed herein has great flexibility in defining the widths of each entry or group of entries.

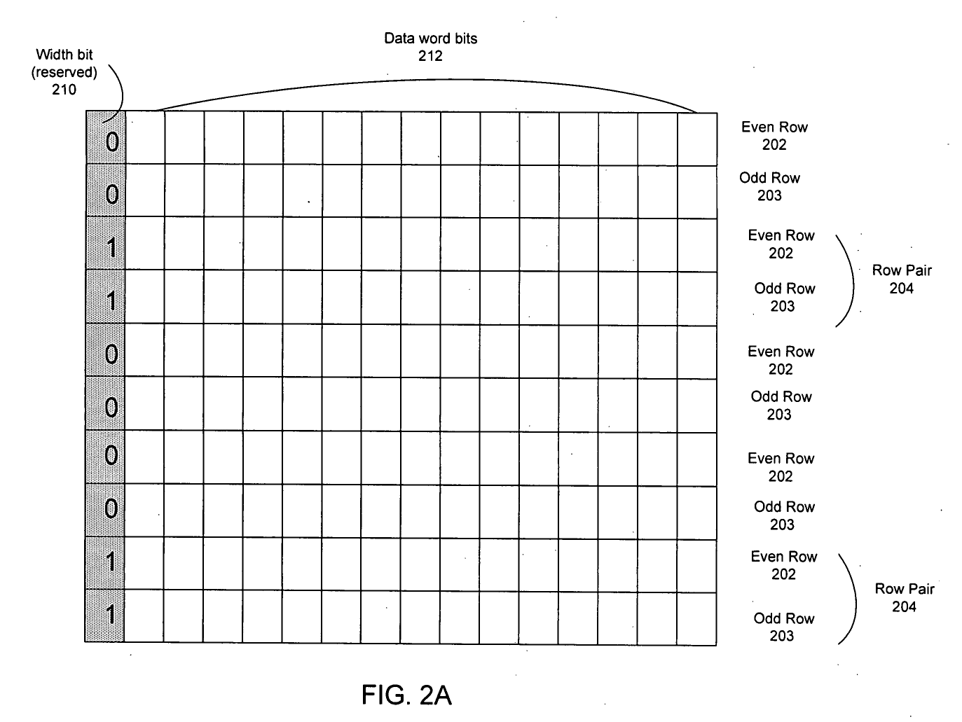

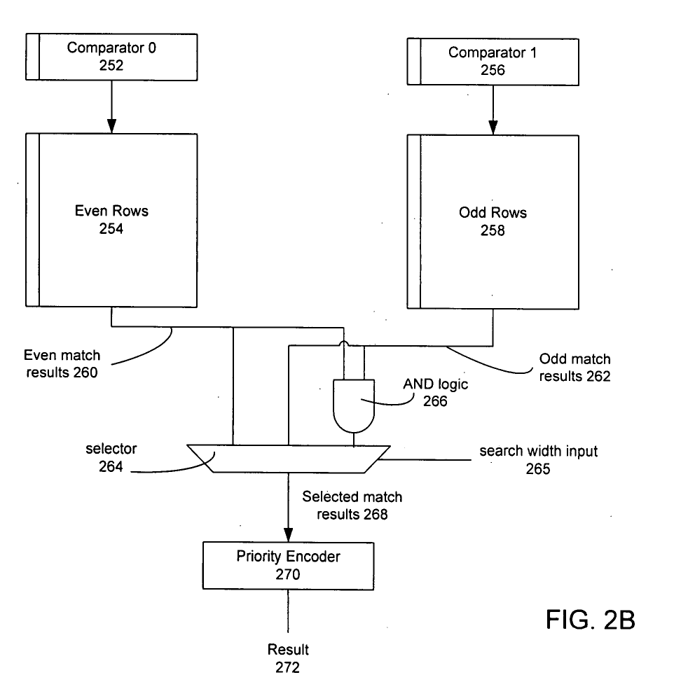

FIG. 2A is a diagram depicting an array of data rows (202 and 203) in a CAM supporting searches of two different widths in accordance with an embodiment of the invention. In this example array, each data row comprises sixteen bits, and there are only ten rows shown. Here, the number of bits per row and the number of rows are being limited for purposes of illustration. Of course, the number of bits per row may be different for different implementations. In another example, each data row may be 180 bits wide, and there may be several thousand rows in the CAM array.

In accordance with an embodiment of the invention, the rows may be divided into even rows 202 and odd rows 203. The even rows 202 have even addresses (i.e. those addresses with least significant bit being 0), and the odd rows 203 have odd addresses (i.e. those addresses with least significant bit being 1).

There are also two comparator registers, as shown in the circuitry depicted in FIG. 2B. An “even” comparator register (“Comparator 0”) 252 is configured to hold a search word for comparison against bits in the even rows 254, and an “odd” comparator register (“Comparator 1”) 256 is configured to hold a search word for comparison against bits in the odd rows 258.

Returning the discussion to FIG. 2A, one bit in each row is reserved as a “width bit” 210, while the remaining fifteen bits in each row are “data word bits” 212. The data word bits 212 are the actual data bits that are desired to be compared against search words.

The width bit 210 is used to indicate whether any particular row (202 or 203) comprises a data entry 105 or whether a row pair 204 comprises a data entry 105. A row pair 204 includes an even row 202 and a subsequently adjacent odd row 203 in the CAM array. In the example depicted in FIG. 2, the width bit 210 is set to “1” when a row pair 204 comprises a data entry 105, and the width bit 210 is set to “0” when a single row (202 or 203) comprises a data entry 105.

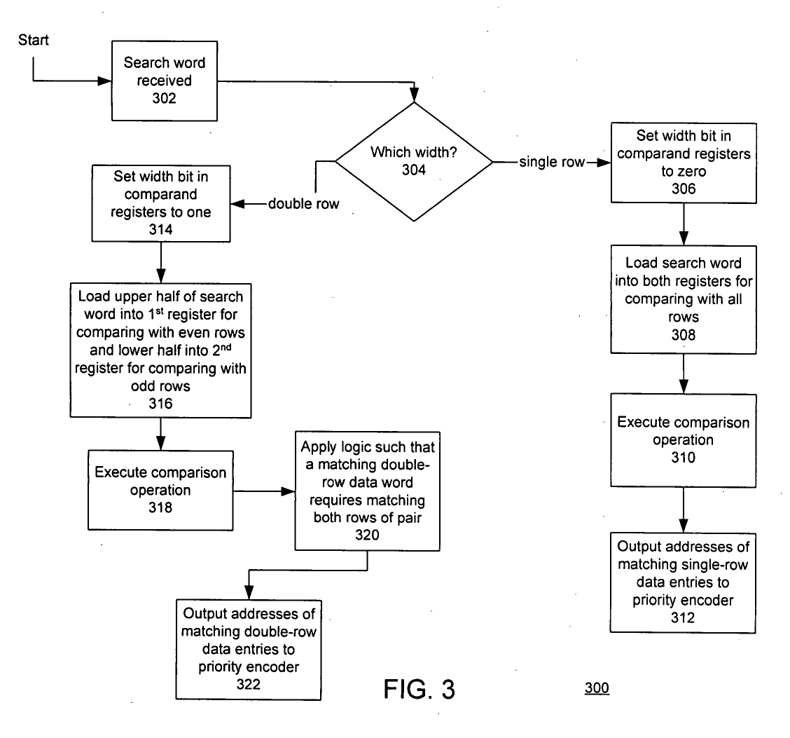

FIG. 3 is a flow chart depicting a method 300 of performing a search over the example CAM of FIG. 2A in accordance with an embodiment of the invention. A search word of a supported width is received 302 by the CAM. Here, the search word may be of two different widths: first width being within a single row of the CAM; and the second width being within two rows of the CAM. Upon receipt of the search word, a determination 304 is made by logic as to whether the search word is of the first width or of the second width.

If the search word is of the first width (single row), then the width bit 210 in both of the comparand registers is set 306 to 0. In addition, the same search word bits are loaded 308 into the data word bits 212 of both registers. By doing so, the search word may be compared with data in each individual row in the CAM. The comparison operation is then executed 310 in the CAM array. In this comparison, a row that is a member of a row pair 204 cannot produce a match because its width bit 210 does not match that in the corresponding register. On the other hand, a row that is not a member of a row pair 204 can produce a match if all of its data word bits 212 match those in the corresponding register. The CAM array may then output 312 the addresses of the matching single-row data entries. The output may be sent, for example, to a priority encoder 107.

On the other hand, if the search word is of the second width (double row), then the width bit 210 in both of the comparand registers is set 314 to 1. In addition, bits from the upper half of the search word may be loaded 316 into the data word bits 212 of a first of the two comparand registers, and bits from the lower half of the search word may be loaded 316 into the data word bits 212 of the other comparand register. By doing so, the search word may be compared with data in row pairs 204 in the CAM. The comparison operation is then executed 318 in the CAM array. In this comparison, a row that is not a member of a row pair 204 cannot produce a match because its width bit 210 does not match that in the corresponding register. On the other hand, a row that is a member of a row pair 204 can produce a match if all of its data word bits 212 match those in the corresponding register. Logic circuitry is then applied 320 such that a matching double-row data word requires matching both individual rows of a row pair 204. The CAM array may then output 322 the addresses of the matching double-row data entries. The output may be sent, for example, to a priority encoder 107.

Returning to FIG. 2B, the even row match results 260 and the odd row match results 262 are “directly” input to a selector circuit 264. In addition, AND logic 266 is applied to the corresponding even and odd match results (such that a match is indicated only if both even and odd rows of a row pair match), and the resultant row pair match results are input to the selector 264.

The selector 264 is controlled by a search width input 265. If the search width input 265 indicates a single row search word, then the selector 264 selects the “direct” even and odd match results (260 and 262). On the other hand, if the search width input 265 indicates a double row search word, then the selector 264 selects the row pair match results (from the AND logic 266). The selected match results 268 may be sent by the selector 264 to a priority encoder 270 which may be configured to generate an address that indicates one of the matching entries.

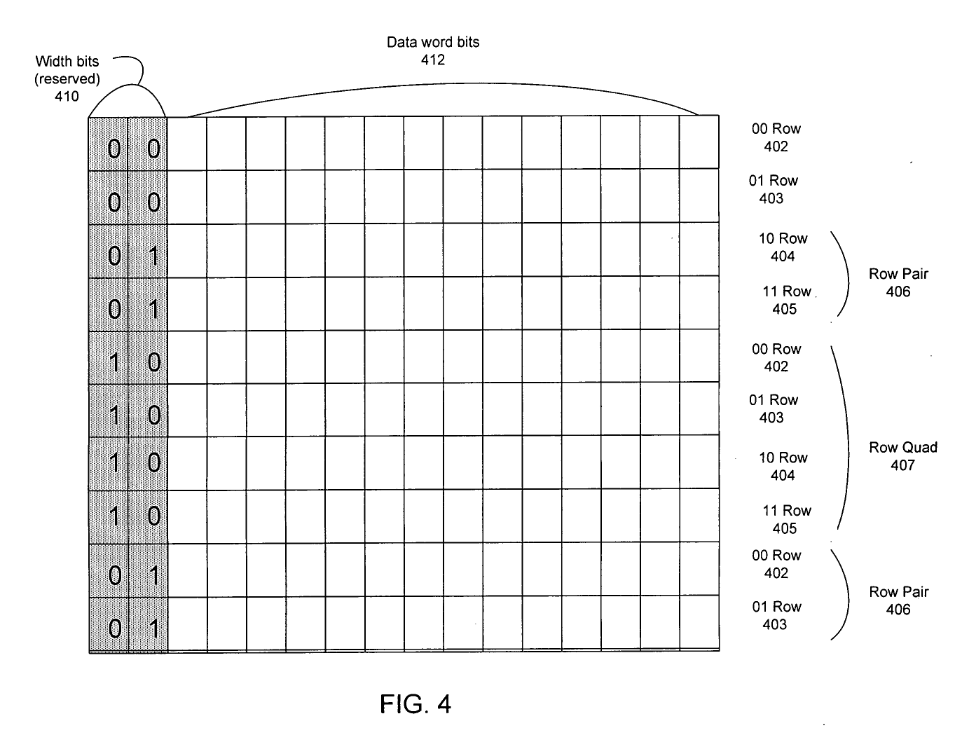

FIG. 4 is a diagram depicting an array of data rows (402, 403, 404, and 405) in a CAM supporting searches of three different widths in accordance with an embodiment of the invention. In this example array, each data row comprises sixteen bits, and there are only ten rows shown. Again, the number of bits per row and the number of rows are being limited for purposes of illustration.

Of course, the number of bits per row may be different for different implementations. In another example, each data row may be 180 bits wide, and there may be several thousand rows in the CAM array.

In accordance with an embodiment of the invention, the rows may be divided into “00” rows 402, “01” rows 403, “10” rows 404, and “11” rows 405. The 00 rows 402 have addresses with two least significant bits being 00. The 01 rows 403 have addresses with two least significant bits being 01. The 10 rows 404 have addresses with two least significant bits being 10. Finally, the 11 rows 10. 405 have addresses with two least significant bits being 11.

There are also four comparator registers (not shown). The “00” comparator register is configured to hold a search word for comparison against bits in the 00 rows 402. The “01” comparator register is configured to hold a search word for comparison against bits in the 01 rows 403. The “10” comparator register is configured to hold a search word for comparison against bits in the 10 rows 404. Finally, the “11” comparator register is configured to hold a search word for comparison against bits in the 11 rows 405.

In accordance with the embodiment of the invention shown in FIG. 4, two bits in each row is reserved as “width bits” 410, while the remaining fourteen bits in each row are “data word bits” 412. The data word bits 412 are the actual data bits that are desired to be compared against search words.

The width bits 410 is used to indicate whether any particular row (402 or 403 or 404 or 405) comprises a data entry 105 by itself, whether a row pair 406 comprises a data entry 105, or whether a “row quad” 407 comprises a data entry 105

A row pair 406 includes an even row (402 or 404) and a subsequently adjacent odd row (403 or 405) in the CAM array. A row quad 407 includes a grouping of four adjacent rows (402, 403, 404 and 405) starting with a 00 row 402 in the CAM array.

In the example depicted in FIG. 4, the width bits 410 are set to “00” when a single row (402 or 403 or 404 or 405) comprises a data entry 105. The width bits 410 are set to “01” when a row pair 406 comprises a data entry 105.

Finally, the width bits 410 are set to “10” when a row quad 407 comprises a data entry 105.

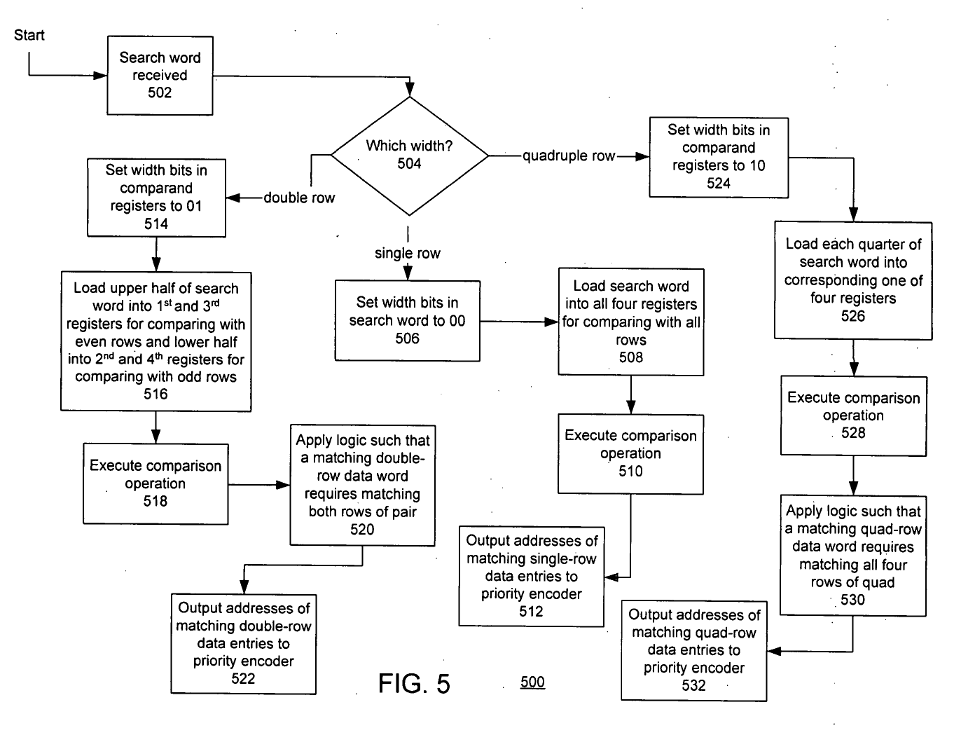

FIG. 5 is a flow chart depicting a method 500 of performing a search over the CAM of FIG. 4 in accordance with an embodiment of the invention. A search word of a supported width is received 502 by the CAM. Here, the search word may be of three different widths: first width being within a single row of the CAM; and the second width being within two rows of the CAM; and a third width being within four rows of the CAM. Upon receipt of the search word, a determination 504 is made by logic as to whether the search word is of the first width, the second width, or the third width.

If the search word is of the first width (single row), then the width bits 410 in the comparand registers are both set 506 to zero (i.e. they are set to 00). In addition, the same search word bits are loaded 508 into the data word bits 412 of each of the comparand registers. By doing so, the search word may be compared with data in each individual row in the CAM. The comparison operation is then executed 510 in the CAM array. In this comparison, a row that is a member of a row pair 406 or a row quad 407 cannot produce a match because its width bits 410 do not match those in the corresponding register. On the other hand, a row that is not a member of a row pair 406 or a row quad 407 can produce a match if all of its data word bits 412 match those in the corresponding register. The CAM array may then output 512 the addresses of the matching single-row data entries. The output may be sent, for example, to a priority encoder 107.

If the search word is of the second width (double row), then the width bits 410 in the comparand registers are set 514 to 01. In addition, bits from the upper half of the search word may be loaded 516 into the data word bits 412 of the first and third comparand registers, and bits from the lower half of the search word may be loaded 516 into the data word bits 412 of the second and fourth comparand registers. By doing so, the search word may be compared with data in row pairs 406 in the CAM. The comparison operation is then executed 518 in the CAM array. In this comparison, a row that is not a member of a row pair 406 cannot produce a match because its width bits 510 do not match. On the other hand, a row that is a member of a row pair 406 can produce a match if all of its data word bits 412 match those in the corresponding register. Logic circuitry is then applied 520 such that a matching double-row data word requires matching both individual rows of a row pair 406. The CAM array may then output 522 the addresses of the matching double-row data entries. The output may be sent, for example, to a priority encoder 107.

If the search word is of the third width (quadruple row), then the width bits 410 in the comparand registers are set 524 to 10. In addition, bits from the first (top) fourth of the search word may be loaded 526 into the data word bits 412 of the first comparand register, bits from the second fourth of the search word may be loaded 526 into the data word bits 412 of the second comparand register, bits from the third fourth of the search word may be loaded 526 into the data word bits 412 of the third comparand register, and bits from the last (bottom) fourth of the search word may be loaded 526 into the data word bits 412 of the fourth comparand register. By doing so, the search word may be compared with data in row quads 407 in the CAM. The comparison operation is then executed 528 in the CAM array. In this comparison, a row that is not a member of a row quad 407 cannot produce a match because its width bits 510 do not match. On the other hand, a row that is a member of a quad pair 407 can produce a match if all of its data word bits 412 match those in the corresponding register. Logic circuitry is then applied 530 such that a matching quad-row data word requires matching all four individual rows of a row quad 407. The CAM array may then output 532 the addresses of the matching quad-row data entries. The output may be sent, for example, to a priority encoder 107.

Note that with two width bits 410 per FIG. 4, the CAM may be configured to support searches with up to four different widths. In addition to the above-discussed single row, double row, and quadruple row entries, “octuple” row (eight adjacent row) entries may be used. Such an octuple row entry would be a grouping of eight adjacent rows starting with a “000” row (a row whose three least significant address bits are 000) in the CAM array. The width bits may be set to 11 to indicate an octuple row entry. In addition, eight comparand registers would be needed. The method of FIG. 5 may then be extended to support searches over four widths (including the octuple row entries).

Further note that the invention is not necessarily limited to searches over widths that are a power of two multiplied by a row length. For example, one embodiment may mix a first search width that is three times a row length (triple-row width) and a second search width that is a single times a row length (single-row width).

Also note that the CAM may be advantageously configured such that every row is capable of storing a searchable entry or part of a searchable entry. In other words, the CAM may be configured so that no row is rendered unusable due to an entry of a certain width in an adjacent row. For instance, in the above example with triple-row and single-row width entries, each triple-row width entry in such a CAM may be aligned on a 00 boundary, and each single-row width entry may be either in the 11 segment of a quad that held a triple-row width entry, or in any segment of a quad that did not have a triple-width entry.

In one specific embodiment of the invention, the CAM architecture discussed above may be utilized in a network switch or router to support searches of two widths in order to switch or route both IPv4 and IPv6 packets. In such an implementation, the CAM array may have several thousand data rows that are 180 bits wide. (Both the care array and the data word array are 180 bits wide.) In the event of an IPv4 packet, a 180 bit wide search is to be performed. While in the event of an IPv6 packet, a 360 bit wide search is to be performed.

In this implementation, the “width bit” of the 180 bit search word is reserved to indicate whether a particular entry is for an IPv4 or an IPv6 search. For example, the width bit may be zero to indicate an IPv4 search, and may be one to indicate an IPv6 search. To configure an IPv4 search, the width bit is set to zero, and the remaining bits of the 180 bit entry hold the balance of the search word. To configure an IPv6 search, an adjacent pair of entries are both configured with the width bit set to one. The upper half of the 360 bit search word is loaded into one entry and the lower half is loaded into the second entry.

When a packet comes in, an identification is made as to whether it is an IPv4 or an IPv6 packet. An indication is made to the compare logic as to whether we are doing an IPv4 or an IPv6 search. If an IPv4 search is performed, then the CAM operates as is typical. If an IPv6 search is being performed, then the CAM does a comparison that requires the word pairs to both match before considering the overall entry to match. Advantageously, by using a bit (the reserved width bit) within the search word itself to indicate IPv4 versus IPv6, all IPv4 entries automatically miss during the IPv6 search, and similarly all IPv6 entries automatically miss during the IPv4 search.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A content addressable memory (CAM) supporting multiple width entries, the CAM comprising:
a plurality of rows for storing bits in an array;
at least one width bit reserved in every row to indicate a width of an entry; and
at least two comparand registers, each comparand register configured to compare bits with a different subset of the rows in the array.

2. The CAM of claim 1, wherein single row and double row entries are supported using one width bit and two comparand registers, and wherein a first comparand register is configured to compare bits with even rows in the array, and a second comparand register is configured to compare bits with odd rows in the array.

3. The CAM of claim 2, further comprising:
logic circuitry configured such that a matching double row entry requires matching both rows of the entry.

4. The CAM of claim 1, wherein single row, double row, and quadruple row entries are supported using two width bits and four comparand registers, and wherein each comparand register is configured to compare bits with a fourth of the rows in the array.

5. The CAM of claim 4, further comprising:
logic circuitry configured such that a matching double row entry requires matching both rows of the entry and a matching quadruple row entry requires matching all four rows of the entry.

6. The CAM of claim 1, wherein single row, double row, quadruple row, and octuple row entries are supported using two width bits and eight comparand registers, and wherein each comparand register is configured to compare bits with an eighth of the rows in the array.

7. The CAM of claim 6, further comprising:
logic circuitry configured such that a matching double row entry requires matching both rows of the entry, a matching quadruple row entry requires matching all four rows of the entry, and a matching octuple row entry requires matching all eight rows of the entry.

8. The CAM of claim 1, wherein the CAM is utilized in a network device to switch or route packets.

9. The CAM of claim 8, wherein the packets comprise Internet Protocol (IP) packets, wherein the CAM includes both IPv4 and IPv6 entries, and wherein the IPv4 entries are single row entries in the CAM, and the IPv6 entries are double row entries in the CAM.

10. A method of searching a content addressable memory (CAM) supporting multiple width entries, the method comprising:
receiving a search word of a supported width;
determining the width of the search word;
setting at least one reserved width bit in multiple comparand registers of the CAM to indicate the width of the search word;
loading the search word into the multiple comparand registers; and
executing a comparison operation.

11. The method of claim 10, wherein single row and double row entries are supported by the CAM using one width bit and two comparand registers, and wherein a top half of the search word is loaded into a first comparand register for comparing with even rows of the CAM, and a bottom half of the search word is loaded into a second comparand register for comparing with odd rows of the CAM.

12. The method of claim 11, further comprising:
applying logic such that a matching double row entry requires matching both rows of the entry.

13. The method of claim 10, wherein single row, double row, and quadruple row entries are supported using two width bits and four comparand registers, and wherein each comparand register is configured to compare bits with a fourth of the rows in the array.

14. The method of claim 13, further comprising:
applying logic such that a matching double row entry requires matching both rows of the entry and a matching quadruple row entry requires matching all four rows of the entry.

15. The method of claim 10, wherein single row, double row, quadruple row, and octuple row entries are supported using two width bits and eight comparand registers, and wherein each comparand register is configured to compare bits with an eighth of the rows in the array.

16. The method of claim 15, further comprising:
applying logic such that a matching double row entry requires matching both rows of the entry, a matching quadruple row entry requires matching all four rows of the entry, and a matching octuple row entry requires matching all eight rows of the entry.

17. The method of claim 10, wherein the method is applied in a network device to switch or route packets.

18. The method of claim 17, wherein the packets comprise Internet Protocol (IP) packets, wherein the supported entries includes both IPv4 and IPv6 entries, and wherein the IPv4 entries are single row entries in the CAM, and the IPv6 entries are double row entries in the CAM.

19. A content addressable memory (CAM) supporting multiple width entries, the CAM comprising:
an input for receiving a search word of different supported widths;
circuitry for identifying the width of the search word;
circuitry for setting at least one reserved width bit in multiple comparand registers of the CAM based on the width of the search word;
circuitry for loading the search word, or portions thereof, into the multiple comparand registers; and
circuitry for executing a comparison operation.

20. The CAM of claim 19, wherein the CAM is configured in a network device to switch or route packets, and the packets comprise Internet Protocol (IP) packets of both IPv4 and IPv6 types.

21. The CAM of claim 19, wherein the supported widths include only widths which are a power of two multiplied by a length of a row of the CAM.

22. The CAM of claim 19, wherein the supported widths include at least one width which is not a power of two multiplied by a length of a row of the CAM.

23. The CAM of claim 22, wherein the supported widths include a single-row width and a triple-row width.

24. The CAM of claim 19, wherein the CAM is configured such that every row is capable of storing a searchable entry or a part of a searchable entry.
